(19) United States
(12) Patent Application Publication
(10) Pub. No.: US 2019/0031443 A1
(43) Pub. Date: Jan. 31, 2019

(54) TRACTION AND POWER SUPPLY SYSTEM FOR AGRICULTURAL ROBOT AND METHOD THEREOF

(71) Applicant: Chen WU, Nanjing (CN)

(72) Inventor: Chen WU, Nanjing (CN)

(21) Appl. No.: 16/073,812

(22) PCT Filed: Dec. 26, 2016
(86) PCT No.: PCT/CN2016/112013

§ 371 Date: Jul. 30, 2018

(30) Foreign Application Priority Data
Feb. 4, 2016 (CN) 201610078234.7

(51) Int. Cl. B65G 35/00; G05D 1/10; B61B 7/02

(52) U.S. Cl. CPC B65G 35/00; G05D 1/10; A01D 46/30; G05D 2201/0201; B61B 7/02

(57) ABSTRACT

The present invention discloses a traction and power supply system and method for an agricultural robot. The system includes a traction control system and a traction platform. The traction control system includes a traction control unit, a range sensor and a network communication interface. The traction platform includes a controlled traction control unit, a network communication interface, an aerial support, a traction rope, a traction motor, and a traction support assembly. The method includes the following steps: a location distribution of aerial supports and a route planning of the traction rope are performed according to the terrain and distribution of crops. When the robot needs to be moves, encounters an obstacle, or needs to return to the start-stop point, an interaction of a request instruction and a response instruction between the traction control unit and the controlled traction control unit is carried out through respective network communication interfaces thereof.

### CROSS REFERENCE TO RELATED APPLICATIONS

This application is the national phase entry of International Application PCT/CN2016/112013, filed on Dec. 26, 2016, which is based upon and claims priority to Chinese Patent Application No. 201610078234.7, filed on Feb. 04, 2016, the entire contents of which are incorporated herein by reference.

### TECHNICAL FIELD

The present invention relates to the technical field of agricultural robots, in particular to a system and a method for movement in a field and power supply of agricultural robots.

### BACKGROUND

Existing agricultural robots, such as harvesting robots, move autonomously and automatically in the field mainly by means of wheeled or tracked vehicles and simulated limb walking, etc. The application of these agricultural robots is limited to industrial or quasi-industrial standardized terrain such as plant factories and greenhouses. For complex terrains, such as mountains, hills, water surface, rugged ground, muddy ground, etc., and for high trees with economic value, the available agricultural robot technique that the agricultural robot moves upon the ground lacks economic feasibility and practicability and cannot be popularized and used in a large scale. The main reasons are as follows. The complicated movement mechanical structure, vehicle control, navigation, obstacle avoidance, and path planning techniques are required in a fully autonomous automated movement operation. Autonomous movement also means that the robot is required to carry fuel or large capacity battery by itself, thereby limiting the duration of work, and greatly increasing the weight of the robot. Therefore, in view of the existing movement modes in the field, higher design and manufacturing costs for agricultural robots are required, and these movement modes also require a large amount of operation and maintenance costs during use, which becomes economically difficult for large-scale promotion.

### SUMMARY

### Technical Problems

In order to overcome the problems of high cost and low practicability of the existing vehicle and simulated limb walking, the objective of the present invention is to provide a movement and power supply method of a robot for operation in the field, which is economical and can be applied widespread.

### Technical Solutions

In order to achieve the above-mentioned objective, the present invention provides a movement mode different from the movement upon the ground of the existing robot and a complete flying mode. Instead, the robot is suspended by a rope, the rope is driven by the robot through a remote control, and the robot is pulled to move by the rope, so that the robot moves autonomously. Since power is supplied to the robot through the rope, a continuous operation of the robot can be realized without the need to carry fuel or batteries by the robot itself.

The technical solution of the present invention is as follows. A traction and power supply system and method for an agricultural robot is provided, wherein the system includes a traction control system and a traction platform.

The traction control system includes a traction control unit, a range sensor, and a network communication interface.

The traction platform includes a controlled traction control unit, a network communication interface, an aerial support, a traction rope, a traction motor, and a traction support assembly.

In the method, a location distribution of one or more aerial supports and a route planning of one or more traction ropes are designed according to the terrain and a distribution of crops. The traction rope is supported by the aerial support and suspended in the air. The one or more robots are fixed to the traction rope through the traction support assembly. When the robot needs to move, encounters an obstacle, or needs to return to the start or stop point, an interaction through a request instruction and a response instruction is carried out between the traction control unit and the controlled traction control unit through respective network communication interfaces thereof, and the traction motor is driven to rotate by the controlled traction control unit so as to pull the rope, and the robot is pulled to move by the traction rope.

The method further includes the following steps. The electrical energy required by the robot for the continuous operation is transmitted through the traction rope. By doing so, not only the weight of the robot is reduced, but also the robot is enabled to work continuously for a long time.

### Advantages

The movement mode in the system is different from the movement upon the ground of the existing robot and a complete flying mode. Instead, the robot is suspended by a rope, the rope is driven by the robot through a remote control, and the robot is pulled to move by the rope, so that the robot moves autonomously. Since power is supplied to the robot through the rope, a continuous operation of the robot can be realized without the need to carry fuel or batteries by the robot itself, which is economical and can be applied widespread when the robot is working in the field.

### BRIEF DESCRIPTION OF THE DRAWINGS

FIG. 1 is a schematic diagram of a traction and power supply system for a robot according to an exemplary embodiment of the present invention.

FIG. 2 is a flowchart showing the traction and movement of a robot according to an exemplary embodiment of the present invention.

FIG. 3 is a flowchart showing a robot that stops moving when it encounters an obstacle according to an exemplary embodiment of the present invention.

FIG. 4 is a flowchart showing a robot that returns to the start-stop point according to an exemplary embodiment of the present invention.

### DETAILED DESCRIPTION

### Preferred Embodiment of the Invention

Hereinafter, the technical solution of the embodiment of the present invention will be described clearly and completely with reference to the drawings of the embodiment of the present invention. Apparently, the embodiments described are merely a part of the embodiments of the present invention rather than all. Any other embodiment derived from the embodiments of the present invention by those skilled in the art without creative effort shall be considered as falling within the scope of the present invention.

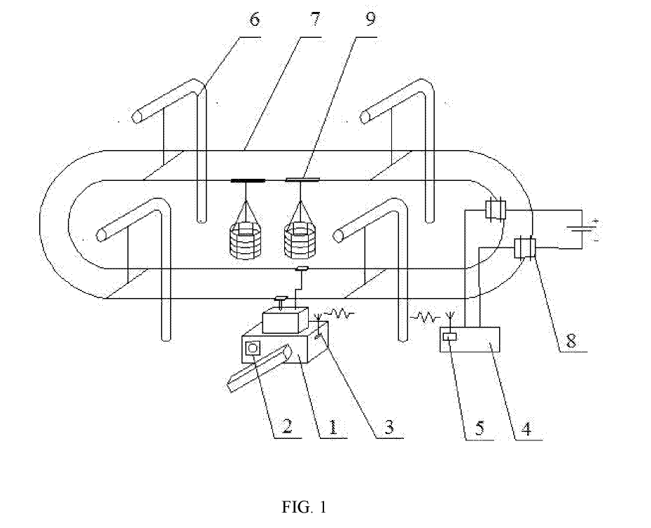

FIG. 1 is a schematic diagram of a traction and power supply system of a robot according to an exemplary embodiment of the present invention. An installation worker of aerial support 6 carries out a location distribution of aerial support 6 and a route planning of traction rope 7 according to the terrain and a distribution of crops. When the robot needs to be moved, encounters an obstacle, or needs to return back to the start-stop point, an interaction through a request instruction and a response instruction is carried out between traction control unit 1 and controlled traction control unit 4 through respective network communication interfaces thereof. Traction motor 8 is driven to rotate by controlled traction control unit 4 so as to pull rope 7, and the robot is pulled to move by traction rope 7. In the schematic diagram of FIG. 1, the electrical energy required by the robot for continuous operation is transmitted through traction rope 7.

### Embodiment of the Invention

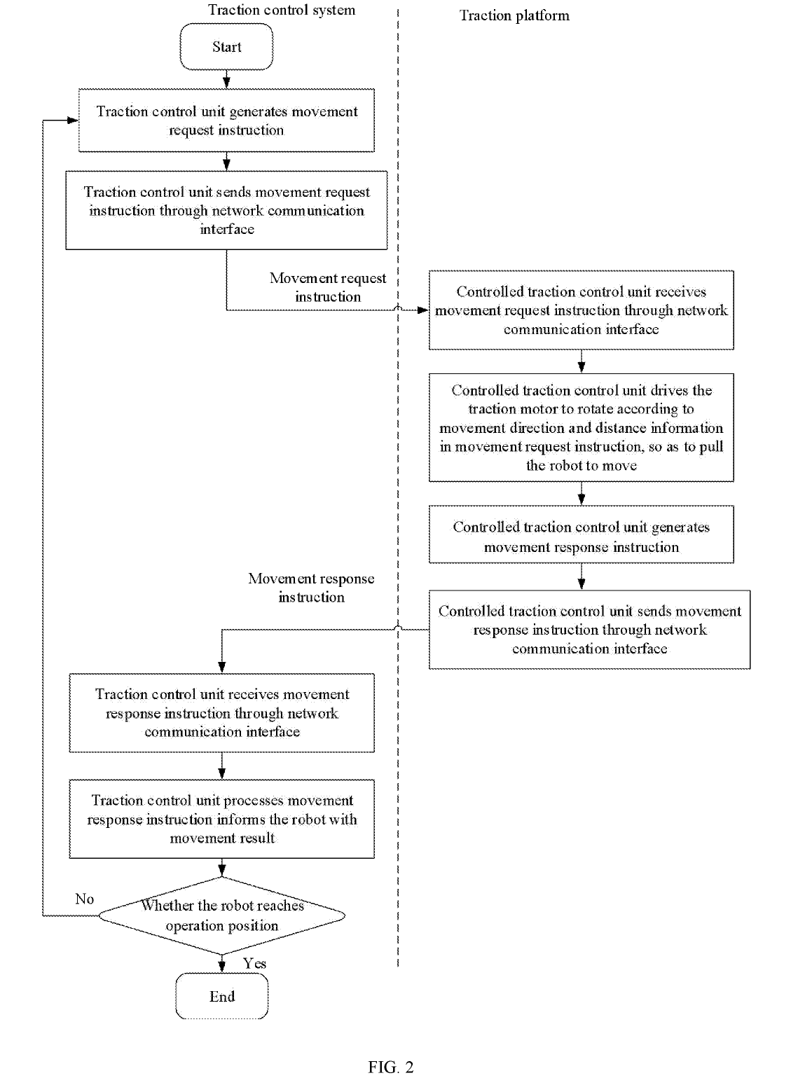

FIG. 2 is a flowchart showing the traction and movement of a robot according to an exemplary embodiment of the present invention. When the robot needs to be moved to an operation position, the robot generates a movement request instruction through traction control unit 1 in the traction control system, and the movement request instruction is sent to controlled traction control unit 4 of the traction platform through network communication interface 3. After the controlled traction control unit 4 receives the movement request instruction through the network communication interface 5, traction motor 8 is driven to rotate according to the movement direction and distance information in the movement request instruction, so as to pull rope 7, and the robot is pulled by traction rope 7 to move. After the traction movement is successfully completed, a movement response instruction is generated by controlled traction control unit 4 and sent to traction control unit 1 through network communication interface 5. The traction control unit 1 receives the movement response instruction through network communication interface 3 and informs the robot with the movement result after the instruction is processed. If the robot has not reached the operation position, the robot can repeat the above-mentioned movement process until it reaches the operation position or stops moving.

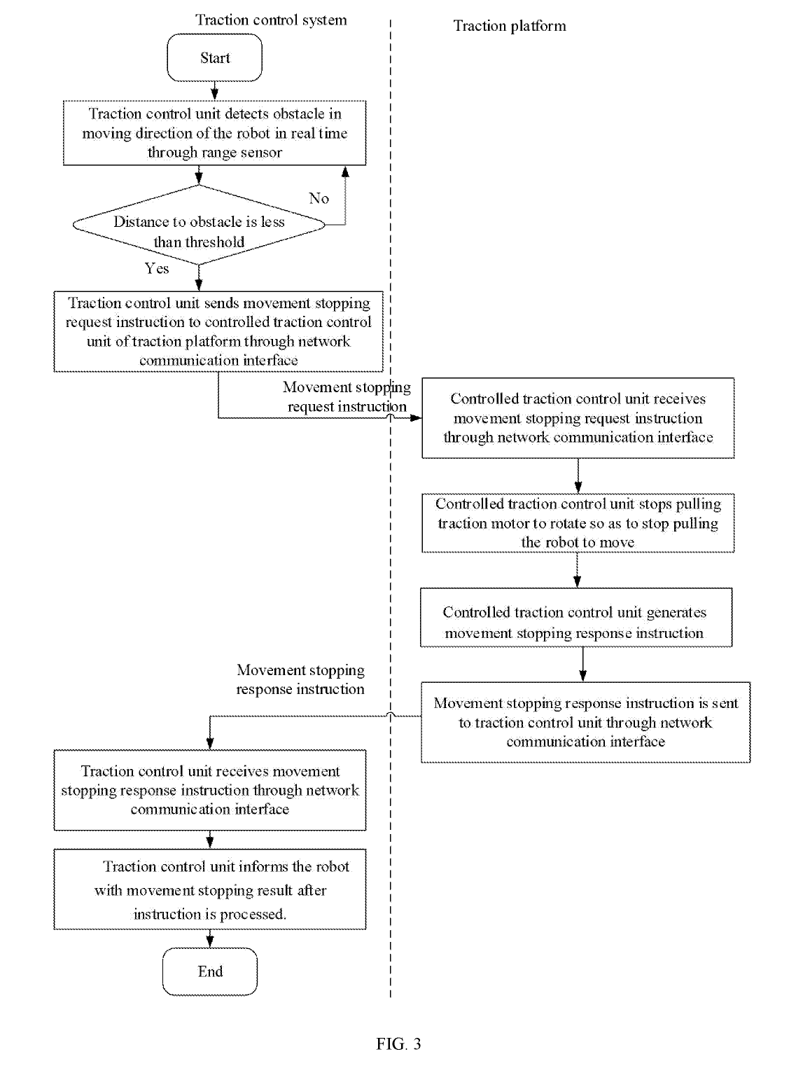

FIG. 3 is a flowchart showing a robot that stops moving when it encounters an obstacle according to an exemplary embodiment of the present invention. When the robot is pulled to move, the distance to the obstacle in a moving direction is detected in real time by traction control unit 1 through range sensor 2. When the distance to the obstacle is less than a threshold, traction control unit 1 sends a movement stopping request instruction to the controlled traction control unit 4 of the traction platform through network communication interface 3. After controlled traction control unit 4 receives the movement stopping request instruction through network communication interface 5, controlled traction control unit 4 stops pulling traction motor 8 to rotate so as to stop pulling the robot to move. Controlled traction control unit 4 generates a movement stopping response instruction and the movement stopping response instruction is sent to traction control unit 1 through the network communication interface 5. Traction control unit 1 receives the movement stopping response instruction through network communication interface 3 and informs the robot with the movement stopping result after the instruction is processed.

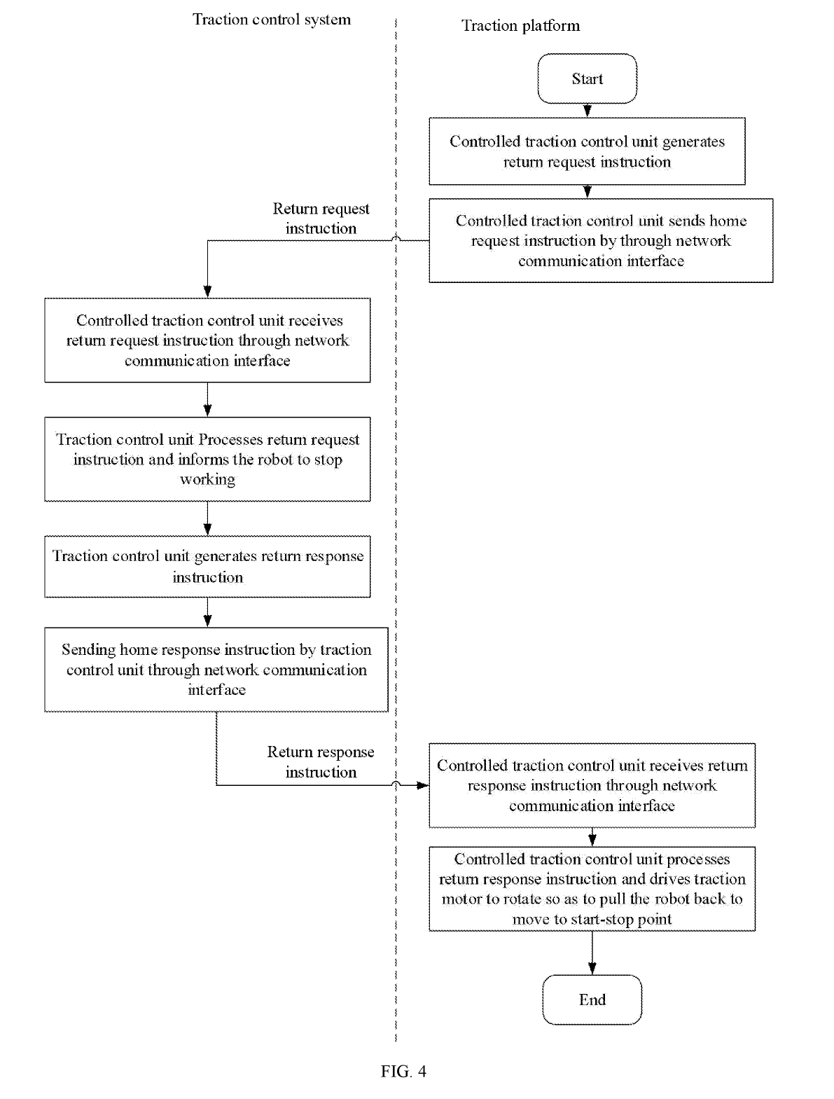

FIG. 4 is a flowchart showing a robot that returns back according to an exemplary embodiment of the present invention. When the robot is working in the field, if the operator needs the robot to return to the start-stop point, a return request instruction is generated by controlled traction control unit 4, and the return request instruction is sent to traction control unit 1 of the traction control system through network communication interface 5. After traction control unit 1 receives the return request instruction through network communication interface 3, the robot is informed to stop working. Traction control unit 1 generates a return response instruction and sends it to controlled traction control unit 4 through network communication interface 5. After the controlled traction control unit 4 receives the return response instruction through network communication interface 5, the traction motor 8 is driven to rotate so as to pull rope 7, and the robot is pulled back to the start-stop point by traction rope 7.

What is claimed is:

1. A traction and power supply system for an agricultural robot, comprising a traction control system and a traction platform, wherein
the traction control system comprises a traction control unit, a range sensor, and a network communication interface; wherein
the traction control unit is configured to generate a movement request instruction and process a movement response instruction;
the range sensor is configured to detect an obstacle in a moving direction of the agricultural robot being pulled;
the network communication interface is configured to send the movement request instruction to the traction platform and receive the movement response instruction from the traction platform;
the traction platform comprises a controlled traction control unit, a network communication interface, an aerial support a traction rope, a traction motor, and a traction support assembly;
the controlled traction control unit is configured to process the movement request instruction and generate the movement response instruction;
the network communication interface is configured to receive the movement request instruction from the traction control system and send the movement response instruction to the traction control system;
the aerial support is configured to support the traction rope;
the traction rope is configured to carry and pull the agricultural robot and a fruit box;
the traction motor is configured to roll the traction rope; and
the traction support assembly is configured to mount and fix the agricultural robot and the fruit box on the traction rope.

2. The traction and power supply system for the agricultural robot according to claim 1, wherein
the aerial support is erected on a ground and enabled to support the traction rope and the agricultural robot and the fruit box supported by the aerial rope to make the aerial rope, the agricultural robot, and the fruit box suspended in the air; and
the aerial support is provided with a pulley structure for the movement and traction of the traction rope.

3. The traction and power supply system for the agricultural robot according to claim 1, wherein the traction rope is a conductive metal rope supported by the aerial support, suspended in the air, pulled by the traction motor to move, and enabled to carry and pull the agricultural robot and the fruit box.

4. The traction and power supply system for the agricultural robot according to claim 1, wherein
the traction motor pulls the traction rope through a rotation of the traction motor;
a safety protection lock pin is provided to prevent the traction motor from idling and accidental reverse rotation;
the traction motor is provided with a hand-operated rotating mechanism; and
the traction motor is rotated by manual operation to withdraw the agricultural robot under an abnormal condition.

5. The traction and power supply system for the agricultural robot according to claim 1, wherein the traction support assembly enables the agricultural robot and the fruit box to be mounted and fixed on the traction rope rapidly, and enables the agricultural robot and the fruit box to be removed from the traction rope rapidly.

6. A traction and power supply method for an agricultural robot, comprising:
performing a location distribution and an installation of at least one aerial support and a route planning of at least one traction rope by an installation worker according to a terrain and a distribution of crops;
suspending the traction rope in the air, wherein the traction rope is supported by the aerial support;
fixing at least one agricultural robot on the traction rope through a traction support assembly, wherein when the at least one agricultural robot needs to be moved, an interaction of a request instruction and a response instruction is carried out between a traction control unit and a controlled traction control unit through respective network communication interfaces thereof, a traction motor is driven to rotate by the controlled traction control unit so as to pull the traction rope, and the agricultural robot is pulled to move by the traction rope; and
transmitting dominant electric energy required for a continuous operation of the agricultural robot through the traction rope.

7. The traction and power supply method according to claim 6, wherein
when the at least one agricultural robot needs to be moved, a movement request instruction is generated by the traction control unit;
the movement request instruction is sent to the controlled traction control unit through a network communication interface;
after the movement request instruction is received by the controlled traction control unit through a network communication interface, the traction motor is driven to rotate by the controlled traction control unit to pull the traction rope, so that the traction rope pulls the agricultural robot to move in a field.

8. The traction and power supply method according to claim 6, wherein
the traction control unit detects an obstacle in a moving direction of the agricultural robot in real time through a range sensor;
when the agricultural robot is pulled to move, if the obstacle in the moving direction of the agricultural robot being pulled is detected by the traction control unit through the range sensor in real time, a stop moving request instruction is sent to a traction platform immediately;
after a stop moving instruction is received by the controlled traction control unit, the traction of the traction motor is stopped so that the agricultural robot stops moving.

9. The traction and power supply method according to claim 6, wherein
the controlled traction control unit sends a return request instruction to the traction control system to require the agricultural robot to stop working;
after the agricultural robot successfully responds to the return request instruction, the traction motor is driven by the controlled traction control unit to move the agricultural robot to a start-stop point through the traction rope.
